(19) United States
(12) Patent Application Publication
(10) Pub. No.: US 2026/0352499 A1
(43) Pub. Date: Nov. 5, 2026

(54) SENDING AND RECEIVING BLOCKCHAIN DATA

(71) Applicant: nChain Licensing AG, Zug (CH)

(72) Inventors: Alessio PAGANI, London (GB); Jack DAVIES, London (GB); Mathieu DUCROUX, London (GB); Craig Steven WRIGHT, London (GB)

(21) Appl. No.: 19/153,512

(22) PCT Filed: Feb. 15, 2024
(86) PCT No.: PCT/EP2024/053829

§ 371 Date: Aug. 4, 2025

(30) Foreign Application Priority Data
Feb. 20, 2023 (GB) 2302367.4

(51) Int. Cl. H04L 9/00; H04L 9/32

(52) U.S. Cl. CPC H04L 9/50; H04L 9/3239

(57) ABSTRACT

A computer-implemented method of obtaining application-related data, wherein the method is performed by a first party and comprises:
determining a first multicast network address associated with a first application; and
obtaining, using the first multicast address, one or more respective blockchain transactions and/or one or more respective proof of inclusions, each respective proof of inclusion associated with a respective blockchain transaction, wherein each respective blockchain transaction comprises respective data related to the first application.

### CROSS REFERENCE TO RELATED APPLICATIONS

This application is the U.S. National Stage of International Application No. PCT/EP 2024/053829 filed on Feb. 15, 2024, which claims the benefit of United Kingdom Patent Application No. 2302367.4, filed on Feb. 20, 2023, the contents of which are all incorporated herein by reference in their entireties.

### TECHNICAL FIELD

The present disclosure relates to methods of sending and receiving blockchain data, e.g. transactions and SPV proofs, using multicast addresses.

### BACKGROUND

The Internet Protocol (IP) suite currently has two competing technical designs IPv4 and IPv6, corresponding to versions 4 and 6 of the IP respectively, for assigning IP addresses and routing packets of data between a sender and receiver over the Internet. A key distinction between the two is that IPv6 is accompanied by a range of IP address types, such as unicast, anycast and multicast.

The most widely adopted type of address is unicast. Unicast allows to transmit a packet to a single recipient. This is usually enough for most client services and applications. However, two other types of address are used for specialised enterprise networks: multicast and anycast. Anycast allows for a single operation to transmit a packet to one recipient out of a set of recipients. It is not available for IPv4 (it could be implemented with some workarounds), while it is natively supported by IPv6. Multicast allows for a single operation to transmit a packet to multiple recipients. It is optional (and not widely adopted) in IPv4, while it is natively part of the IPv6 specifications.

IP multicast enables a source host to transmit IP packets to one or more destination hosts identified by a single group address. The packets transmitted are replicated inside the IP network by routers at the point where paths diverge such that a single packet destined for a particular group has to be sent by the source host, resulting in the most efficient delivery of data to multiple receivers. One link may transmit to one or more multicast groups and a host may be part of more than one multicast group. Any host, regardless of whether it is a member of a multicast group, may send packets to it, but only the group members receive the packets.

IP multicast is designed for applications and services in which the same data needs to simultaneously reach many hosts connected to a network. Example applications include videoconferencing, corporate communications, and the distribution of news, software, stock quotes. The source host could support these applications by learning the IP addresses of N destination hosts, establishing N connections with them, and transmitting N copies of each packet. In contrast, IP multicast is more efficient because the source host has to learn a single group address and transmit a single packet to reach the N destination hosts. IP multicast differs from broadcast in that packets are not sent to an entire subnetwork but rather to a selected group of hosts that can be on different subnetworks and have registered themselves to the group. Another difference is that while broadcast only supports one-to-many types of communication, multicast also supports many-to-many types of communication. Any IP network concerned with reducing network resource overhead for one-to-many or many-to-many data or multimedia applications with multiple receivers benefits from multicast.

While both IPv4 and IPv6-based network support IP multicast but in this paper, the limited address space of IPv4 limits the IPv4 multicast's ability to reach the increasing number of Internet-attached devices. In addition, the common use of Network Address Translation (NAT) vehicles that convert public IPv4 addresses to private addresses makes it very difficult, if not impossible, to support certain applications that use multicast connectivity. Globally unique IPv6 addresses eliminates the needs for NAT boxes and simplify multicast communication between hosts. In particular, IPv6's larger address space reduces the possibility that separate multicast streams from different sources use the same group address and interfere. IPv6 multicast also more clearly defines domain control, the ability to prevent multicast leaks outside of an administrative region, and makes it easier to allocate and manage multicast groups.

As FIG. 3 illustrates, the basic format of an IPv6 multicast address includes the following elements:
Prefix: all IPv6 multicast addresses begin with the hex 0xFF to identify them as multicast addresses.
Flags: indicates how the address was allocated or if it might contain additional information. The Internet Assigned Numbers Authority (IANA) has allocated a set of permanently assigned multicast addresses for specific functions. Other flags include: the T flag for temporarily assigned address, the P flag for addresses derived from a unicast-based IPv6 network prefix, the R flag to signal that a rendezvous-point (RP) address is embedded.
Scope: constrains the distance a multicast packet can travel. This prevents multicast packets from crossing administrative network boundaries and traversing links and networks in which they don't belong.
Group ID: identifies a specific multicast group address (belonging to a host interface).

### SUMMARY

As blockchain-based applications grow, the number of transactions being published increases and, consequently, the blockchain size increase. In the next years an even more rapid growth is expected. A group of users may use the same application (e.g. an application other than Bitcoin) and use the blockchain to record application-specific data. They may only be interested in receiving transactions related to this application. With the current infrastructure, users interested in specific data are either required to run a blockchain node or rely on a third party running a node. This node has to listen to all the blockchain-related traffic and filter the transactions they are interested in. Alternatively each user needs to subscribe to one or more existing network nodes and receive SPV proofs of publication. However, existing network nodes are not required to serve SPV proofs as for them it is an additional cost (especially as the blockchain usage grows).

There is therefore a need to be able to efficiently obtain transactions having application-specific data without having to obtain or listen for all transactions, including those not relating to the application of interest.

According to one aspect disclosed herein, there is provided a computer-implemented method of obtaining application-related data, wherein the method is performed by a first party and comprises:
determining a first multicast network address associated with a first application; and
obtaining, using the first multicast address, one or more respective blockchain transactions and/or one or more respective proof of inclusions, each respective proof of inclusion associated with a respective blockchain transaction, wherein each respective blockchain transaction comprises respective data related to the first application.

Each application is an application other than bitcoin. An application may be a blockchain application, but not the bitcoin blockchain. Each application may be a different application.

According to another aspect disclosed herein, there is provided a computer-implemented method of propagating application-related data, wherein the method is performed by a second party and comprises:
determining a first multicast network address associated with a first application;
sending, to the first multicast address, one or more respective blockchain transactions and/or one or more respective proof of inclusions, each respective proof of inclusion associated with a respective blockchain transaction, wherein each respective blockchain transaction comprises respective data related to the first application.

Embodiments of the present disclose provide techniques for optimising traffic management on the blockchain to enable users to receive only the transactions they are interested in. This creates an overlay network with all the transactions required to run a specific application. Only blockchain nodes that take an active part in the validation process (e.g. blockchain nodes) may choose to receive all the transactions, as they need to validate each transaction and produce new blocks.

As disclosed herein, an overlay network is established by partitioning network traffic using (e.g. IPv4 or IPv6) multicast addresses linked to uses-cases and/or applications. This way, users and other interested parties listen just to the part of the traffic they are interested in. The traffic relative to an application may include transactions sent for publication from a user/application, transactions published by a node with a respective SPV proof, or any other information that could be of interest or relevance for that application, e.g. alerts, updates, etc.

Several advantages are provided by the provided embodiments. For instance, use-case specific overlay networks reduce overall network traffic (i.e. number of transactions exchanged) as only the interested party receives them. Moreover, only blockchain nodes require specialised hardware and/or software to manage the entire set of transactions being published and to store the whole blockchain. In addition, applications and users are provided with a simplified interface to the blockchain. They need only submit transactions to a multicast address linked to the application and, optionally, wait for an SPV proof, rather than connecting to a blockchain node.

Multicast addresses may be assigned to specific applications, such as central bank digital currencies (CBDCs) or social media protocols. A given user, as part of an overlay network or otherwise, may wish to subscribe to multicast addresses for many such applications. It is therefore desirable that the user can communicate efficiently with a router to ascertain the set of multicast addresses it requires. There is therefore a need for a way to efficiently map and manage the set of all multicast addresses, each corresponding to a different type of network traffic.

According to another aspect disclosed herein, there is provided a computer-implemented method for facilitating transmission and reception of application-related data, wherein a plurality of respective multicast addresses are associated with a plurality of respective applications, wherein the method is performed by a third party and comprises:
maintaining a mapping between the plurality of respective multicast addresses and the plurality of respective applications;
receiving, from a requesting party, a request for a set of respective multicast addresses associated with a set of respective applications, the set of respective applications belonging to the plurality go respective applications; and
sending, to the requesting party, the requested set of respective multicast addresses.

According to another aspect disclosed herein, there is provided a computer-implemented method for facilitating transmission and reception of application-related data, wherein a plurality of respective multicast addresses are associated with a plurality of respective applications, wherein the method is performing by a fourth party and comprises: comprising:
maintaining a mapping between the plurality of respective multicast addresses and the plurality of respective applications; and
making the mapping and/or a commitment of the mapping available to one or more parties.

In some embodiments the mapping is a hash tree, e.g. a Merkle tree. The use of a Merkle tree, or equivalent, allows nodes to track the set of network traffic types being used using the same principles as used for transactions. The Merkle tree allows for efficient storage and update of the set from the perspective of nodes. The Merkle tree root gives a lightweight representation of the set that can easily be passed around and checked by other entities within an overlay network, such as routers, to improve the consistency of service providers.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3 schematically illustrates the basic format of an IPv6 multicast address,

FIG. 4 schematically illustrates an example system for propagating application-related data,

FIG. 5 schematically illustrates an example system of parties interacting via a multicast address,

FIG. 6 schematically illustrates an example Merkle tree encoding a set of multicast addresses, and

FIG. 7 shows an example flow for requesting and providing multicast addresses.

### DETAILED DESCRIPTION OF EMBODIMENTS

### 1. Propagating Application-Related Data

Embodiments of the present disclosure enable parties to communicate blockchain-based application-related data. Such data may be communicated without having to interact directly with the blockchain network 106. FIG. 4 shows an example system 400 of parties which make use of multicast addresses to communicate data. The example system 400 includes a first party 401, a second party 402, a third party 403 and a fourth party 404. Each party operates respective computing equipment configured to perform the actions described below as being performed by that party. In some examples, the first party 401 and/or second party 402 is a user, such as Alice 103a or Bob 103b. In some examples, the first party 401 is a blockchain node 104. In some examples, the third party 403 is a network router. In some examples, the fourth party 404 is a blockchain node 104. Whilst shown separately, in some examples one or more parties may be the same party. For instance, the first party 401 and the fourth party 404 may be a blockchain node 104.

Embodiments make use of multicast addresses for communicating application-specific data. An application may take any form, such as a protocol, e.g. a communication protocol such as instant messaging, or a token protocol such as a CBDC. Each application is associated with (i.e. assigned) a dedicated multicast address, e.g. an IPv4 or IPv6 multicast address. The multicast address associated with a particular application may be assigned by the application owner (e.g. a social media platform) or by a standards agency. A multicast address may be generated based on the application, e.g. the name of the application. A multicast address may be cryptographically linked to the application.

The second party 402 is configured to determine (e.g. obtain, receive, generate) a first network address associated with a first application. The first network address may be obtained from a public resource, such as the blockchain, or from the application owner (i.e. the application provider), or a different party. As shown in FIG. 4, the first network address may be provided to the second party 402 by the third party 403. More on this below.

The second party 402 sends a blockchain transaction containing data relating to the first application to the first multicast address. That is, the blockchain transaction is sent over the internet addressed to the first multicast address. The skilled person is familiar with how to route data to a multicast address. The second party 402 may send multiple blockchain transactions containing data relating to the first application to the first multicast address.

The application-related data may be any type of data, including payment data. E.g. the application may be a payment processor, in which case the application data may include the public key or public key hash of a recipient, a signature of the sender, etc.

Additionally or alternatively, the second party sends, to the first multicast address, a proof of inclusion for a blockchain transaction containing data relating to the first application. A proof of inclusion provides proof (i.e. can be used to prove) that a blockchain transaction has been recorded on the blockchain 150. An example of a proof of inclusion is a Merkle proof. A particular example of a proof of inclusion is a simplified verification proof (SPV). The skilled person will be familiar with SPVs. The second party 402 may send multiple proof of inclusions to the first multicast address, where each proof proves that a particular blockchain transaction containing data relating to the first application has been recorded on the blockchain 150.

The second party 402 may determine multiple multicast addresses, each associated with a particular application. For example, the second party 402 may receive a list of addresses from the third party 403, as discussed further below. The second party 402 may send transactions containing data related to a particular application and/or proof of inclusions of transactions containing data related to a particular application to (i.e. addressed to) the multicast address associated with that particular application.

The first party 401 is also configured to determine (e.g. obtain, receive, generate) a first multicast address associated with the first application. The first party 401 may determine the first multicast address in any of the ways described above for the second party, including requesting and receiving the first multicast address from the third party 403.

The first party 401 subscribes to (i.e. listens to/monitors) the first multicast address for blockchain messages relating to the first application. In any case, the first party 401 is configured to retrieve data sent to the first multicast address. Here, a blockchain message may include a blockchain transaction and/or a proof of inclusion of a blockchain transaction. For instance, the first party 401 may receive, by subscribing to the first multicast address, a transaction submitted to the first multicast address by the second party 401.

The first party 401 may perform one or more actions in response to obtaining the blockchain transaction(s) and/or proof(s). As an example, the first party 401 may store, in memory, the blockchain transaction(s) and/or proof(s). As another example, the first party 401 may send one or more of the blockchain transactions to one or more parties, e.g. one or more blockchain nodes 104. The first party 401 may publish one or more of the blockchain transactions on the blockchain 150. In some examples, the first party 401 may first validate one or more of the blockchain transactions, and publish only the validated transactions on the blockchain 150.

Once published on the blockchain 150, the first party 401 may send a respective proof of inclusion (e.g. SPV proof) for the published transaction to the first network address. The second party 402 may retrieve a proof of inclusion sent to the first network address by the first party 401 to determine whether a transaction has been published on the blockchain 150.

The second party 402 may determine multiple multicast addresses, each associated with a particular application. For example, the first party 402 may receive a list of addresses from the third party 403, as discussed further below. The first party 402 may retrieve transactions containing data related to a particular application and/or proof of inclusions of transactions containing data related to a particular application from (i.e. addressed to) the multicast address associated with that particular application.

In some examples, each application may be associated with multiple multicast addresses. Each address may be used for a particular purpose, e.g. one for transactions, one for SPV proofs, one for payments, one for updates, etc.

Note that in general the first party 401 may perform any of the actions performed by the second party 402 and vice versa.

As mentioned above, the third party 403 may provide one or more multicast addresses to the first party 401 and/or the second party 402. The third party 403 may comprise a network router which may be configured to route traffic on the network 101.

Each application is associated with (i.e. assigned) a multicast address. The third party 403 maintains a mapping between the applications and the associated multicast addresses. The third party 403 is configured to receive a request for the respective multicast address of one or more applications, e.g. from the first party 401 and/or the second party 402. In response, the third party 403 uses the mapping to determine the requested multicast addresses and sends them to the requesting party, e.g. the first party 401 and/or the second party 402.

The mapping may be in the form of a Merkle tree. One or more leaves of the Merkle tree are generated based on respective multicast addresses. That is, each multicast address is hashed, separately, to form a respective leaf hash of the Merkle tree. Each application may be assigned an index of the Merkle tree, with the associated multicast address being hashed to form a leaf hash at that index of the Merkle tree.

The third party 403 may retrieve a list of applications for which multicast addresses are requested. The third party 403 may determine a list of indices based on the list of applications, and look-up the multicast addresses of the Merkle tree occupying positions corresponding to those indices. The third party 403 may verify that the multicast addresses at those positions correspond to the requested applications, and only supply a multicast address to the requesting party if it does correspond to the requested application.

The fourth party 404 (e.g. a blockchain node 104) may also maintain the same mapping. For example, the fourth party 404 may generate the mapping. The fourth party 404 may supply the mapping to the third party 403. In the case that the mapping is a Merkle tree, the fourth party 404 may supply the whole Merkle tree or just the Merkle root. The Merkle root may be signed by the fourth party 404. The third party 403 may use the Merkle root to verify its own Merkle tree.

### 1.1 Specific Examples

Embodiments of the present disclosure enables users and other types of parties to transmit and receive application-related data stored on or otherwise associated with the blockchain, e.g. transactions or Merkle proofs, such as simplified payment verification (SPV) proofs. This SECTION provides specific examples of the embodiments described above.

Each relevant application may be associated to a multicast address. The association may be, for example:
a multicast address cryptographically linked to an application, or
a multicast address assigned by a third-party (e.g. IANA, the global coordination of the DNS Root, IP addressing, and other Internet protocol resources).

In the latter case, the application may needs to apply for address assignment. Users, devices, and other interested parties may subscribe to that multicast address to receive updates as described above.

Blockchain nodes 104 may subscribe to all the multicast addresses (or at least the majority of them) in order to receive transactions, validate and publish them. Once a transaction is published, an SPV proof may be broadcast to the same multicast address to inform the other parties involved, e.g. application users. It may be responsibility of the multicast address creator to notify the network nodes 104 that they need to subscribe to their address. Alternatively, applications may use multiple multicast addresses dedicated to specific traffic (e.g. for sending transactions, receiving SPV proofs). It may be the responsibility of the multicast address creator to notify the network nodes 104 that they need to subscribe to their address.

Blockchain nodes 104 may prune transactions or transaction data after publication. New services to store or backup the data required for a specific application, such as application-specific archival nodes, may emerge in the overlay networks. Users can use these services to retrieve data without the need to query a node 104. The SPV proof acts as a validity certification and tamper-proof mechanism.

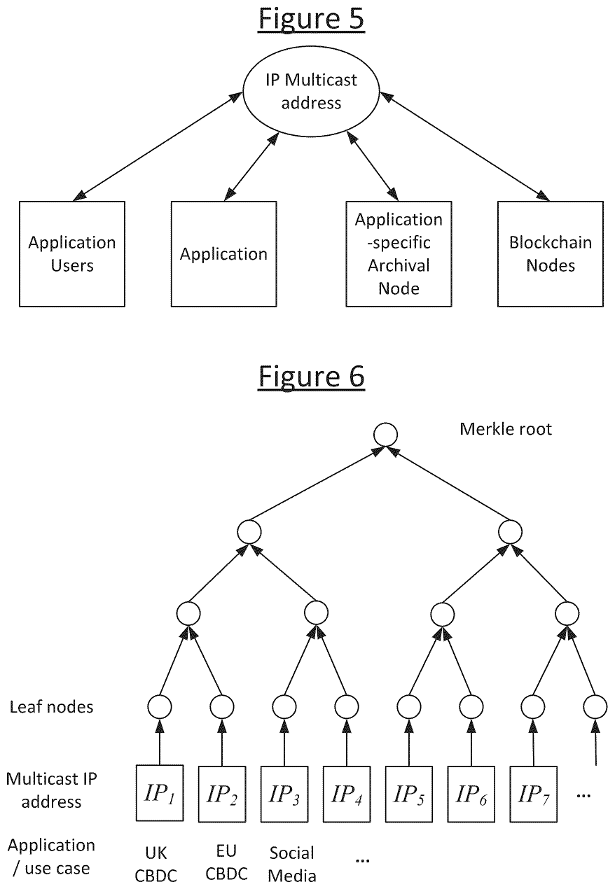

An example flow for a payment with some application-specific data from a user to an application is shown in FIG. 5:
1) An application user sends the transaction containing a payment and some data to multicast address
   a. Application receives payment transaction and data
   b. Network nodes 104 receive the transaction
   c. Archival node store data for future usage
2) Network nodes 104 validate the transaction and insert it in a block
3) Network nodes 104 send transaction SPV proof to multicast address
   a. The application user receives SPV proof that the transaction is published, and optionally stores it for future reference
   b. Application receive SPV proof and process data
   c. Archival node records SPV proof

The application-specific overlay network may continue to use the data certified using the blockchain 150 without further interactions with the network nodes.

Assume that the blockchain network 106, at a given moment, has n_{T} different types of network traffic corresponding to n_{T} different transaction types that are created and broadcast by applications and users. Each distinct protocol, application, or traffic type can be associated with a different registered Multicast address, labelled IP₁, IP₂, . . . , IPₙ_{_{T}}. The order of this index can be arbitrary, or it can optionally be ordered to signify (e.g.) the age of the corresponding protocol or application.

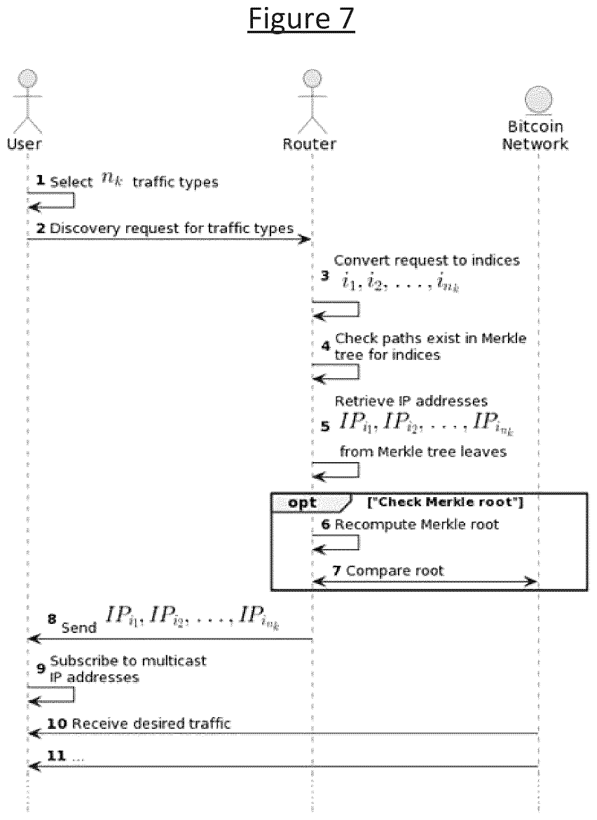

As shown in FIG. 6, a Merkle tree may be formed from any subset of these Multicast IP addresses. This may be done simply by generating a standard binary Merkle tree, such as that used in Bitcoin for transactions, where each leaf node corresponds to the hash of a Multicast IP address. A Merkle tree such as this, which encodes the entire set of Multicast addresses for all types of network traffic on the blockchain 150, may be derived by any blockchain node 104, since they will be receiving and propagating all types of traffic one another as part of the core blockchain network 106. A node 104 may wish to publish their Merkle tree, or at least its root, as an attestation and advertisement of the types of network traffic currently supported by (or seen on) the blockchain network 106. This may be a useful service for application hosts as well as law enforcement and regulatory authorities. The Merkle root may be signed by the node 104, or any party maintaining such a tree, to improve the value of the attestation.

Consider a user or device, labelled A, on the edge of an overlay network based on the core blockchain network, such as a regional CBDC overlay or social media platform. A would like to subscribe to a set of k services or applications, corresponding to nₖ network traffic types. This means that A needs to obtain the nₖ Multicast IP addresses corresponding to these traffic types. To obtain these addresses, A can communicate with a router R that maintains a mapping between traffic types and Multicast IP addresses. R may store this mapping as a Merkle tree, as outlined above. This allows R to efficiently store and lookup a large set of addresses and to check them against any publicly available attestations of network traffic trees published by blockchain nodes 104 in the core node network 106.

An example protocol allowing A to subscribe to nₖ traffic types is as follows:
1. A selects the nₖ traffic types that he wishes to subscribe to.
2. A sends a Multicast discovery request to R for the nₖ traffic types, encoded as (e.g.) a list of traffic type codes or strings.
3. R converts the request into a list of indices i₁, . . . , iₙ_{ₖ} corresponding to the index at which each respective traffic type Multicast address is stored in the Merkle tree.
4. R checks that the leaf nodes at indices i₁, . . . , iₙ_{ₖ} exist and correspond to the expected network traffic types, as requested by A.
   a. R will send a NULL address back to A in step 7 for any indices that fail this test.
5. R retrieves the IP addresses IPᵢ_{₁}, . . . , IPᵢ_{ₙ}ₖ.
6. Optional: R recomputes the Merkle root, using the leaves IPᵢ_{₁}, . . . , IPᵢ_{ₙ}ₖ and the corresponding partial Merkle proof, and compares to a published version of root.
7. R sends IPᵢ_{₁}, . . . , IPᵢ_{ₙ}ₖ to A in response to their request.
8. A begins receiving the desired traffic sent to the Multicast IP addresses IPᵢ_{₁}, . . . , IPᵢ_{ₙ}ₖ.

The purpose of step 4 is for the router to check that a registered Multicast IP address exists for each given network traffic type. In other words, this step is used to check that a routing path exists for A to subscribe to a Multicast IP address for each traffic type.

At step 6, R can optionally recompute the Merkle root of its local tree and compare it to the published root of a node to check that the addresses are up-to-date and still valid.

In general, nₖ need not be equal to k. It may also be some function of k, depending on the types of network traffic and how they are generated.

A process diagram of the example protocol is shown in FIG. 7.

The following features are provided by one or more embodiments of the present disclosure.

Multicast addresses may be used to create partitions of the blockchain network (i.e. overlay networks), based on specific applications or use-cases.

Multicast addresses are linked to applications. The link may be a multicast address cryptographic linked to an application or a multicast address assigned by a third-party.

Interested users and other parties may subscribe to an application-specific multicast address to receive application-specific traffic.

Applications and users may send transactions related to an application to the relative multicast address, meaning there is no requirement to identify and communicate with network nodes 104.

Network nodes may subscribe to all the multicast address to receive transactions for validation and publication.

Network nodes may publish an SPV proof to the same multicast address to notify the interested parties that the transaction has been published.

An application may use multiple multicast addresses. For example, one to broadcast transactions and one to receive to SPV proof.

The following use cases may be realised using the embodiments described herein.

A central bank may release a blockchain-based CBDC solution and monitor all the related transactions without the need to set-up a full node. Similarly, a user may send a direct payment (peer-to-peer) to another user. The payee broadcasts the transaction for publication in the blockchain, and both receive an SPV confirmation from the blockchain nodes 104.

A videogame may use the blockchain to record transactions. Players may subscribe to the multicast address to receive updates. In an even lighter approach, multicast addresses may be linked to different part of the game (e.g. different worlds, circuits, battles depending on the game).

A blockchain node 104 may specialise in validating transactions from multicast addresses. It processes them with high priority and responds quickly with SPV proofs. The blockchain node 104 may charge for premium services to applications and services that are willing to pay for priority or guaranteed SPV proofs.

A storage service may subscribe to a multicast address, store data and SPV proofs and sell access to data related to the specific application or use-case. Blockchain nodes 104 may prune the data, without impacting the functioning of applications and overlay networks.

A router service may help connect users to blockchain-based applications such as CBDCs.

Client-side software or devices that enable access to blockchain-based applications may establish subscriptions to many streams of network traffic.

### 2. Example System Overview

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example, blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

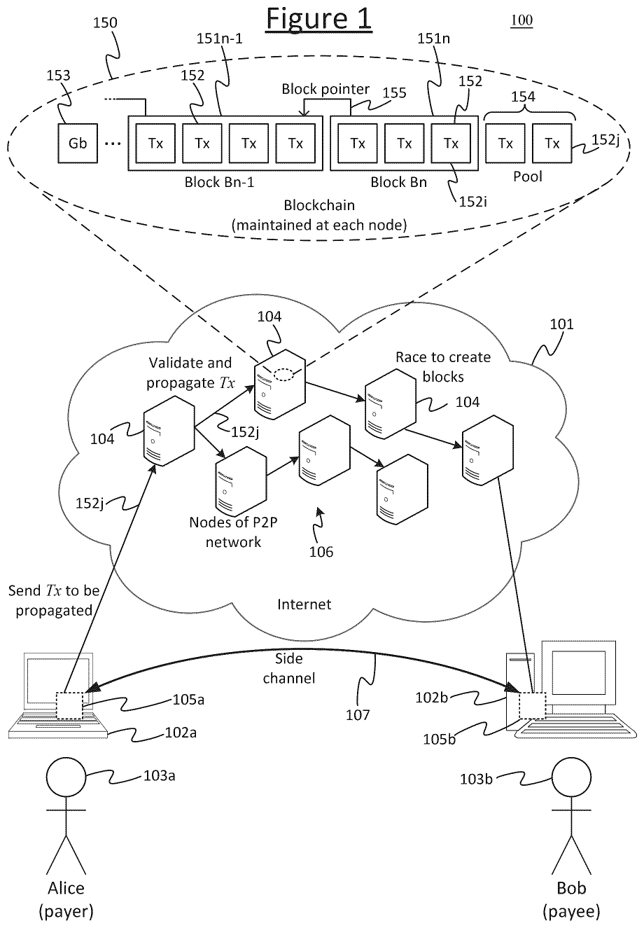

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 (often referred to as “miners”) that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout.

A blockchain node 104 may be configured to forward transactions 152 to other blockchain nodes 104, and thereby cause transactions 152 to be propagated throughout the network 106. A blockchain node 104 may be configured to create blocks 151 and to store a respective copy of the same blockchain 150 in their respective memory. A blockchain node 104 may also maintain an ordered set (or “pool”) 154 of transactions 152 waiting to be incorporated into blocks 151. The ordered pool 154 is often referred to as a “mempool”.

This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. Spending or redeeming does not necessarily imply transfer of a financial asset, though that is certainly one common application. More generally spending could be described as consuming the output, or assigning it to one or more outputs in another, onward transaction. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Any given blockchain node may be configured to perform one or more of the following operations: validating transactions, storing transactions, propagating transactions to other peers, performing consensus (e.g. proof-of-work)/mining operations. In some examples, each type of operation is performed by a different node 104. That is, nodes may specialise in particular operation. For example, a nodes 104 may focus on transaction validation and propagation, or on block mining. In some examples, a blockchain node 104 may perform more than one of these operations in parallel. Any reference to a blockchain node 104 may refer to an entity that is configured to perform at least one of these operations.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility).

The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position” or “nonce”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

Some account-based transaction models share several similarities with the output-based transaction model described herein. For example, as mentioned above, the data field of an account-based transaction may point back to a previous transaction, which is equivalent to the input of an output-based transaction which references an outpoint a previous transaction. Thus both models enable linking between transactions. As another example, an account-based transaction contains a “recipient” field (in which a receiving address of an account is specified) and a “value” field (in which an amount of digital asset may be specified). Together the recipient and value fields are equivalent to the output of an output-based transaction which may be used to assign an amount of digital asset to a blockchain address. Similarly, an account-based transaction has a “signature” field which includes a signature for the transaction. The signature is generated using the sender's private key and confirms the sender has authorized this transaction. This is equivalent to an input/unlocking script of an output-based transaction which, typically, includes a signature for the transaction. When both types of transaction are submitted to their respective blockchain networks, the signatures are checked to determine whether the transaction is valid and can be recorded on the blockchain. On an account-based blockchain, a “smart contact” refers to a transaction that contains a script configured to perform one or more actions (e.g. send or “release” a digital asset to a recipient address) in response to one or more inputs (provided by a transaction) meeting one or more conditions defined by the smart contact's script. The smart contract exists as a transaction on the blockchain, and can be called (or triggered) by subsequent transactions. Thus, in some examples, a smart contract may be considered equivalent to a locking script of an output-based transaction, which can be triggered by a subsequent transaction, and checks whether one or more conditions defined by the locking script are met by the input of the subsequent transaction.

### 3. UTXO-Based Model

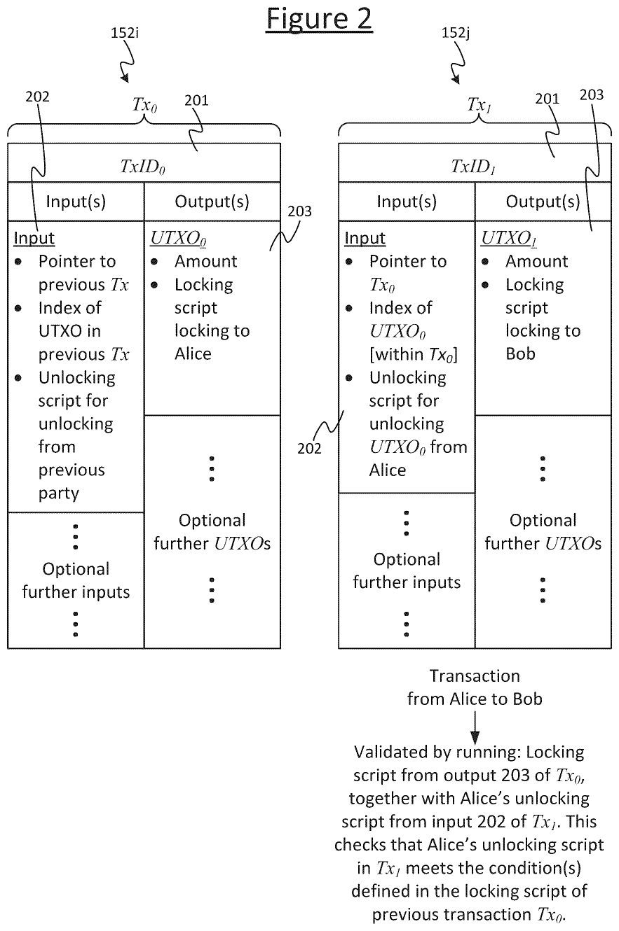

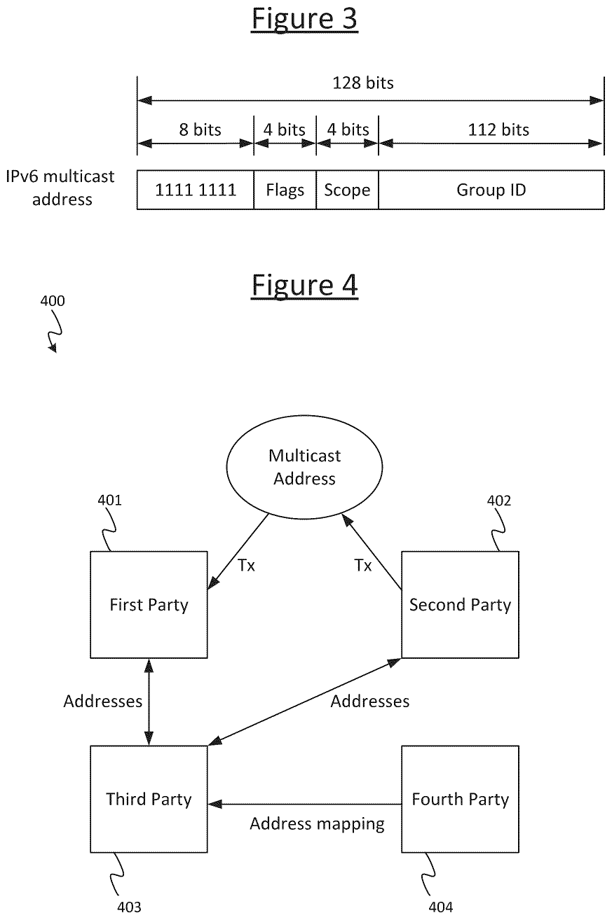

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Locking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig PA of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria).

Note that the script code is often represented schematically (i.e. not using the exact language). For example, one may use operation codes (opcodes) to represent a particular function. “OP_ . . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### Further Remarks

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

Some embodiments have been described in terms of the blockchain network implementing a proof-of-work consensus mechanism to secure the underlying blockchain. However proof-of-work is just one type of consensus mechanism and in general embodiments may use any type of suitable consensus mechanism such as, for example, proof-of-stake, delegated proof-of-stake, proof-of-capacity, or proof-of-elapsed time. As a particular example, proof-of-stake uses a randomized process to determine which blockchain node 104 is given the opportunity to produce the next block 151. The chosen node is often referred to as a validator. Blockchain nodes can lock up their tokens for a certain time in order to have the chance of becoming a validator. Generally, the node who locks the biggest stake for the longest period of time has the best chance of becoming the next validator.

It will be appreciated that the above embodiments have been described by way of example only. More generally there may be provided a method, apparatus or program in accordance with any one or more of the following Statements.

Statement 1. A computer-implemented method of obtaining application-related data, wherein the method is performed by a first party and comprises:
determining a first multicast network address associated with a first application; and
obtaining, using the first multicast address, one or more respective blockchain transactions and/or one or more respective proof of inclusions, each respective proof of inclusion associated with a respective blockchain transaction, wherein each respective blockchain transaction comprises respective data related to the first application.

Statement 2. The method of statement 1, comprising storing the one or more respective blockchain transactions and/or the one or more respective proof of inclusions.

Statement 3. The method of statement 1 or statement 2, comprising sending the one or more respective blockchain transactions and/or the one or more respective proof of inclusions to one or more parties.

Statement 4. The method of any preceding statement, comprising validating the one or more respective blockchain transactions according to a blockchain protocol.

Statement 5. The method of statement 4, comprising publishing, to the blockchain, one, some or all of the one or more respective blockchain transactions that is validated.

Statement 6. The method of any preceding statement, comprising:
obtaining a respective proof of inclusion for one, some or all of the one or more respective blockchain transactions that is published to the blockchain; and
sending the respective proof of inclusions to the first multicast address.

Statement 7. The method of any preceding statement, comprising:
using one, some or all of the one or more respective proof of inclusions to verify that the associated respective blockchain transaction is published on the blockchain.

Statement 8. The method of any preceding statement, wherein said determining comprises generating the first multicast address.

Statement 9. The method of any of statements 1 to 7, wherein said determining comprises receiving the first multicast address.

Statement 10. The method of statement 9, comprising sending a request, to a third party, for a respective network address associated with one or more respective applications, wherein the one or more respective applications comprise the first application.

Statement 11. The method of any preceding statement, wherein said obtaining comprises monitoring the first multicast address for one or more respective blockchain transactions and/or one or more respective proof of inclusions.

Statement 12. The method of any preceding statement, wherein the first multicast address is generated based on the first application.

Statement 13. The method of statement 12, wherein the first multicast address is cryptographically linked to the first application.

Statement 14. The method of any preceding statement, wherein the first multicast address is an IPv4 or IPv6 address.

Statement 15. The method of any preceding statement, comprising:
determining a plurality of respective multicast addresses, each respective multicast address associated with a respective application; and
for each respective application, obtaining, using the respective multicast address, one or more respective blockchain transactions and/or one or more respective proof of inclusions, each respective proof of inclusion associated with a respective blockchain transaction, wherein each respective blockchain transaction comprises respective data related to the respective application.

Statement 16. The method of any preceding statement, comprising:
determining one or more additional multicast network addresses associated with the first application; and
obtaining, using the one or more additional multicast network addresses, one or more respective blockchain transactions and/or one or more respective proof of inclusions, each respective proof of inclusion associated with a respective blockchain transaction, wherein each respective blockchain transaction comprises respective data related to the first application.

Statement 17. The method of statement 16, wherein each of the one or more additional multicast network addresses is associated with a respective purpose and/or type of data sent to and/or from the respective multicast network address.

Statement 18. The method of statement 16 or statement 17, wherein the one or more respective blockchain transactions are obtained from the first multicast network address and the one or more respective proof of inclusions are obtained from one of the one or more additional multicast network addresses.

Statement 19. A computer-implemented method of propagating application-related data, wherein the method is performed by a second party and comprises:
determining a first multicast network address associated with a first application;
sending, to the first multicast address, one or more respective blockchain transactions and/or one or more respective proof of inclusions, each respective proof of inclusion associated with a respective blockchain transaction, wherein each respective blockchain transaction comprises respective data related to the first application.

Statement 20. The method of statement 19, comprising obtaining, using the first multicast address, a respective proof of inclusion associated with the one or more respective blockchain transactions sent to the first multicast address.

Statement 21. The method of statement 19 or 20, wherein said determining comprises receiving the first multicast address.

Statement 22. The method of statement 21, comprising sending a request, to a third party, a respective network address associated with one or more respective applications, wherein the one or more respective applications comprise the first application.

Statement 23. The method of statement 19 or any statement dependent thereon, comprising:
determining one or more additional multicast network addresses associated with the first application; and
sending, to the one or more additional multicast network addresses, one or more respective blockchain transactions and/or one or more respective proof of inclusions, each respective proof of inclusion associated with a respective blockchain transaction, wherein each respective blockchain transaction comprises respective data related to the first application.

Statement 24. The method of statement 23, wherein each of the one or more additional multicast network addresses is associated with a respective purpose and/or type of data sent to and/or from the respective multicast network address.

Statement 25. The method of statement 23 or statement 24, comprising:
sending the one or more respective blockchain transactions to the first multicast network address and the one or more respective proof of inclusions to one of the additional multicast network addresses.

Statement 26. A computer-implemented method for facilitating transmission and reception of application-related data, wherein a plurality of respective multicast addresses are associated with a plurality of respective applications, wherein the method is performed by a third party and comprises:
maintaining a mapping between the plurality of respective multicast addresses and the plurality of respective applications;
receiving, from a requesting party, a request for a set of respective multicast addresses associated with a set of respective applications, the set of respective applications belonging to the plurality go respective applications; and
sending, to the requesting party, the requested set of respective multicast addresses.

Statement 27. The method of statement 26, wherein the mapping comprises a hash tree, wherein a plurality of respective leaf hashes of the hash tree are generated by hashing a respective one of the plurality of respective multicast addresses.

Statement 28. The method of statement 27, wherein each respective application is associated with a respective index of the hash tree, and wherein the method comprises:
converting the requested set of respective multicast addresses associated with a set of respective applications into a list of indices, each index in the list corresponding to the respective index associated with the respective application associated with the requested multicast address; and
verifying that each respective leaf hash of the hash tree occupying a respective position associated with a respective index in the set of indices corresponds to a respective requested multicast address.

Statement 29. The method of statement 26 or any statement dependent thereon, wherein the respective indices associated with the respective applications are assigned according to a respective age of the respective application.

Statement 30. The method of statement 26 or any statement dependent thereon, comprising:
obtaining a target root hash of a target hash tree, wherein the target root hash is generated by a blockchain node; and
verifying that a root hash of the hash tree corresponds to the target root hash.

Statement 31. The method of statement 30, wherein the target root hash is signed by the blockchain node.

Statement 32. A computer-implemented method for facilitating transmission and reception of application-related data, wherein a plurality of respective multicast addresses are associated with a plurality of respective applications, wherein the method is performing by a fourth party and comprises: comprising:
maintaining a mapping between the plurality of respective multicast addresses and the plurality of respective applications; and
making the mapping and/or a commitment of the mapping available to one or more parties.

Statement 33. The method of statement 32, wherein the mapping comprises a hash tree, wherein a plurality of respective leaf hashes of the hash tree are generated by hashing a respective one of the plurality of respective multicast addresses, and wherein the commitment is a root hash of the hash tree.

Statement 34. Computer equipment comprising:
memory comprising one or more memory units; and
processing apparatus comprising one or more processing units, wherein the memory stores code arranged to run on the processing apparatus, the code being configured so as when on the processing apparatus to perform the method of any of statements 1 to 33.

Statement 35. A computer program embodied on computer-readable storage and configured so as, when run on one or more processors, to perform the method of any of statements 1 to 33.

According to another aspect disclosed herein, there may be provided a method comprising the actions of any of the first party, the second party, the third party, and the fourth party. According to another aspect disclosed herein, there may be provided a system comprising the computer equipment of the first party, the second party, the third party, and the fourth party.

1. A computer-implemented method of obtaining application-related data, wherein the method is performed by a first party and comprises:
determining a first multicast network address associated with a first application; and
obtaining, using the first multicast address, one or more respective blockchain transactions and/or one or more respective proof of inclusions, each respective proof of inclusion associated with a respective blockchain transaction, wherein each respective blockchain transaction comprises respective data related to the first application.

2. The method of claim 1, comprising storing the one or more respective blockchain transactions and/or the one or more respective proof of inclusions.

3. The method of claim 1, comprising sending the one or more respective blockchain transactions and/or the one or more respective proof of inclusions to one or more parties.

4-5. (canceled)

6. The method of claim 1, comprising:
obtaining a respective proof of inclusion for one, some or all of the one or more respective blockchain transactions that is published to the blockchain; and
sending the respective proof of inclusions to the first multicast address.

7. The method of claim 1, comprising:
using one, some or all of the one or more respective proof of inclusions to verify that the associated respective blockchain transaction is published on the blockchain.

8. The method of claim 1, wherein said determining comprises generating the first multicast address.

9. The method of claim 1, wherein said determining comprises receiving the first multicast address.

10. (canceled)

11. The method of claim 1, wherein said obtaining comprises monitoring the first multicast address for one or more respective blockchain transactions and/or one or more respective proof of inclusions.

12. The method of claim 1, wherein the first multicast address is generated based on the first application.

13-14. (canceled)

15. The method of claim 1, comprising:
determining a plurality of respective multicast addresses, each respective multicast address associated with a respective application; and
for each respective application, obtaining, using the respective multicast address, one or more respective blockchain transactions and/or one or more respective proof of inclusions, each respective proof of inclusion associated with a respective blockchain transaction, wherein each respective blockchain transaction comprises respective data related to the respective application.

16. The method of claim 1, comprising:
determining one or more additional multicast network addresses associated with the first application; and
obtaining, using the one or more additional multicast network addresses, one or more respective blockchain transactions and/or one or more respective proof of inclusions, each respective proof of inclusion associated with a respective blockchain transaction, wherein each respective blockchain transaction comprises respective data related to the first application.

17. The method of claim 16, wherein each of the one or more additional multicast network addresses is associated with a respective purpose and/or type of data sent to and/or from the respective multicast network address.

18. (canceled)

19. A computer-implemented method of propagating application-related data, wherein the method is performed by a second party and comprises:
determining a first multicast network address associated with a first application;
sending, to the first multicast address, one or more respective blockchain transactions and/or one or more respective proof of inclusions, each respective proof of inclusion associated with a respective blockchain transaction, wherein each respective blockchain transaction comprises respective data related to the first application.

20. The method of claim 19, comprising obtaining, using the first multicast address, a respective proof of inclusion associated with the one or more respective blockchain transactions sent to the first multicast address.

21-22. (canceled)

23. The method of claim 19, comprising:
determining one or more additional multicast network addresses associated with the first application; and
sending, to the one or more additional multicast network addresses, one or more respective blockchain transactions and/or one or more respective proof of inclusions, each respective proof of inclusion associated with a respective blockchain transaction, wherein each respective blockchain transaction comprises respective data related to the first application.

24. (canceled)

25. The method of claim 23, comprising:
sending the one or more respective blockchain transactions to the first multicast network address and the one or more respective proof of inclusions to one of the additional multicast network addresses.

26. A computer-implemented method for facilitating transmission and reception of application-related data, wherein a plurality of respective multicast addresses are associated with a plurality of respective applications, wherein the method is performed by a third party and comprises:
maintaining a mapping between the plurality of respective multicast addresses and the plurality of respective applications;
receiving, from a requesting party, a request for a set of respective multicast addresses associated with a set of respective applications, the set of respective applications belonging to the plurality go respective applications; and
sending, to the requesting party, the requested set of respective multicast addresses.

27. The method of claim 26, wherein the mapping comprises a hash tree, wherein a plurality of respective leaf hashes of the hash tree are generated by hashing a respective one of the plurality of respective multicast addresses.

28. The method of claim 27, wherein each respective application is associated with a respective index of the hash tree, and wherein the method comprises:
converting the requested set of respective multicast addresses associated with a set of respective applications into a list of indices, each index in the list corresponding to the respective index associated with the respective application associated with the requested multicast address; and
verifying that each respective leaf hash of the hash tree occupying a respective position associated with a respective index in the set of indices corresponds to a respective requested multicast address.

29. (canceled)

30. The method of claim 26, comprising:
obtaining a target root hash of a target hash tree, wherein the target root hash is generated by a blockchain node; and
verifying that a root hash of the hash tree corresponds to the target root hash.

31-35. (canceled)
